(19) United States
(12) Patent Application Publication
(10) Pub. No.: US 2008/0256071 A1
(43) Pub. Date: Oct. 16, 2008

(54) Method And System For Selection Of Text For Editing

(76) Inventors: Datta G. Prasad, Karnataka (IN); Anjaneyulu Kuchibhotla, Karnataka (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 12/067,177

(22) PCT Filed: Oct. 31, 2005
(86) PCT No.: PCT/IN05/00349

§ 371 Date: Mar. 18, 2008

(51) Int. Cl. G06F 17/30; G10L 15/26

(52) U.S. Cl. 707/6; 704/235; 704/E15.001

(57) ABSTRACT

A method of selection of text for editing is provided. The method includes inputting text to an apparatus and generating a label for at least one unit of the text as the text is being input to the apparatus. Accordingly, a user is able to select the at least one text unit for editing by selecting the corresponding label of the text unit.

### FIELD OF THE INVENTION

The invention relates generally to text editing, and more particularly, to a method and a system for selection of text for editing.

### BACKGROUND OF THE INVENTION

Speech recognition is a process of analyzing speech input to determine its content. Speech recognition systems are used widely nowadays in many devices for controlling the functions of the devices. For example, a mobile phone user may speak to the mobile phone speaker the name of the person he or she wants to call. A processor in the mobile phone analyzes the speech of the user using a speech recognition technique and dials the number for that person.

Speech recognition is also used widely for dictation purposes. In a typical dictation application, a user provides speech input to a speech recognition system. The speech recognition system identifies the speech input by using acoustic models. The identified speech input is subsequently converted into recognized text and displayed to the user.

Speech recognition systems typically perform at much less than 100% accuracy. Therefore, speech recognition systems normally also provide error correction for correcting text. A typical error correction method includes proof-reading the recognized text, selecting a wrongly recognized word, and correcting the selected word. The user may correct the selected word by re-dictating the word. The system may also generate an alternate word list for the selected word, and the user corrects the selected word by choosing the correct word from the alternate word list.

The wrongly recognized word in the speech recognition system may be selected by using a mouse or any input pointing device. However, the use of a mouse or any input pointing device may not be convenient when the dictation function is used in devices which do not have any input pointing device, for example, mobile phones.

It is also possible to select the wrongly recognized word using voice. For example, the user may issue a voice command “edit word DATA”. The system then looks for the most recent occurrence of the word DATA and selects it. However, the selection of the wrongly recognized word using voice is prone to errors. Also, even when both modes of word selection using an input pointing device or a voice command are provided, the switching between these two modes of word selection is not convenient.

Therefore, it is desirable to have an improved and accurate way of selecting the wrongly recognized word or text unit for editing.

### SUMMARY OF THE INVENTION

In an embodiment, a method for selection of text for editing is provided. The method includes inputting text to an apparatus and generating a label for at least one unit of the text as the text is being input to the apparatus. Accordingly, a user is able to select the at least one text unit for editing by selecting the corresponding label of the text unit.

### BRIEF DESCRIPTION OF THE DRAWINGS

The embodiments of the invention will be better understood in view of the following drawings and the detailed description.

FIG. 1 shows a block diagram of a system for selection of text for editing according to an embodiment.

FIG. 2 shows an example of an implementation of the system for selection of text for editing in a computer system.

FIG. 3 shows a flow-chart of a method for selection of text for editing according to an embodiment.

FIG. 4 shows a flow-chart of a detailed example of the method for selection of text for editing according to an embodiment.

FIG. 5 shows an example of the labels being displayed in parenthesis at the right of each word according to an embodiment.

FIG. 6 shows an example of a text passage with corresponding labels and secondary labels according to an embodiment.

### DETAILED DESCRIPTION OF THE INVENTION

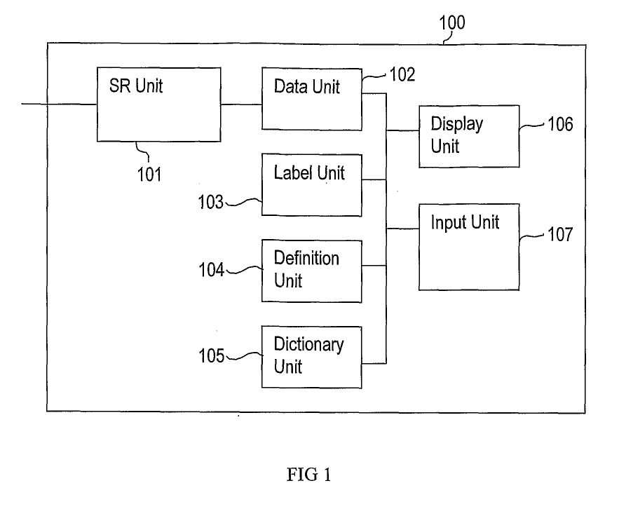

FIG. 1 shows a block diagram of a system 100 for selection of text for editing according to an embodiment. In this embodiment, the text is obtained via Speech Recognition. The system 100 includes a Speech Recognition (SR) unit 101 for receiving speech input. The speech input may be provided from a user through dictation. The SR unit 101 recognizes the speech input using a speech recognition algorithm and converts the recognized speech input into text. Any existing speech recognition systems, such as those provided by Dragon systems or ScanSoft may be used. The text converted by the SR unit 101 is received by a data unit 102 for subsequent processing.

In an alternative embodiment, the text may be directly provided to the data unit 102 in electronic form for processing. The text may be a Short Message Service (SMS) message received in a mobile phone which a user wishes to edit and retransmit. The text may able be pre-existing text received by a device, for example a Personal Computer (PC) or a Personal Digital Assistant (PDA), electronically. Therefore in this alternative embodiment, the SR unit 101 may be omitted.

A label unit 103 generates a label for one or more units of the text (text unit). The label for the text unit may be a unique number, character, word or symbol. Each label corresponds to one text unit. Accordingly, the user is able to select each text unit by selecting its corresponding label. A text unit may be a character, a word, a phrase, a sentence, a line of the text or any other suitable units. The text unit may be defined by the user using a definition unit 104 in an embodiment. It is possible to define the text unit to be a word by default in one embodiment. In another embodiment, a line of the text may be defined as a primary text unit, and a word may be defined as a secondary text unit.

The system 100 may include a dictionary unit 105 in one embodiment. The dictionary unit 105 compares the text with a dictionary to determine if the text is correct. The dictionary unit 105 may be a separate unit, or included as part of the SR unit 101. In an embodiment, the label unit 103 generates labels only for text units which have been identified as wrong by the dictionary unit 105.

The system 100 further includes a display unit 106 for displaying the text and its corresponding label on a display screen. In the embodiment where the system includes the dictionary unit 105, only text units identified as wrong by the dictionary unit 105 would have a label being displayed together with them by the display unit 106. The display unit 106 may be a monitor in an embodiment.

When the user dictates to the system 100, he or she is able to see the text units and their corresponding labels being displayed. When the user spots an error in any one of the displayed text unit, he or she selects the corresponding label through an input unit 107 of the system 100. The input unit 107 may include a speech recognition system in one embodiment. In this embodiment, the user selects the desired label by dictating the corresponding label. Accordingly, a speech input is provided by the user through dictation to the speech recognition system in the input unit 107 and is recognized. Based on the recognized speech input, the corresponding label is selected. In an alternative embodiment, the input unit 107 may be a keyboard and the user selects the label by pressing one or more corresponding keys on the keyboard. The system 100 identifies the text unit corresponding to the label selected by the user, and allows the user to edit the text unit, for example, by re-dictating the text for the text unit.

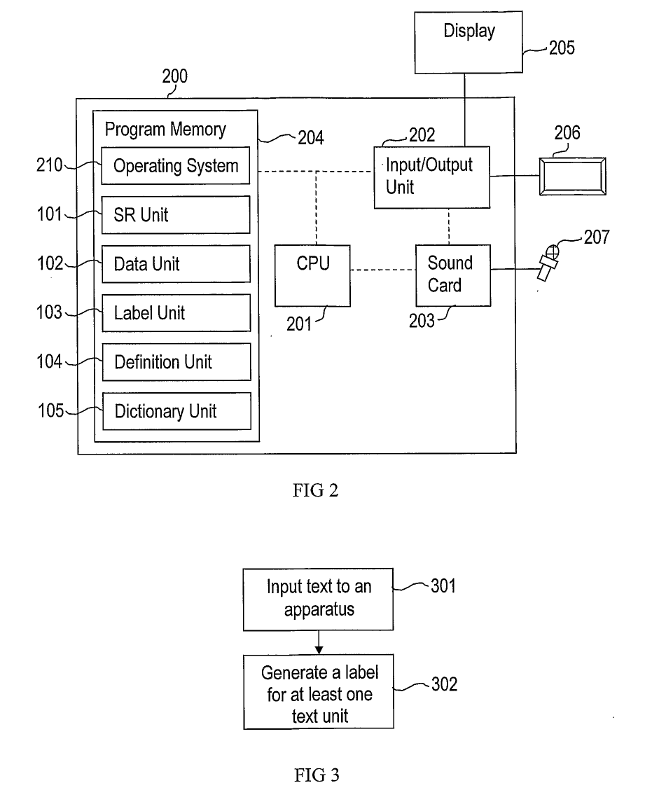

FIG. 2 shows an example of an implementation of the system 100 in a computer system 200. The computer system 200 includes a Central Processing Unit (CPU) 201, an Input-Output (I/O) unit 202, a sound card 203 and a program memory 204. A display 205 and a keyboard 206 are connected to the I/O unit 202. A microphone 207 is connected to the sound card 203. The CPU 201 controls the processes running in the computer system 200.

The program memory 204 stores data and programs such as the operating system 210, the SR unit 101, the data unit 102, the label unit 103, the definition unit 104 and the dictionary unit 105 of the system 100. The I/O unit 202 provides an input and output interface between the computer system 200 and I/O devices such as the display 205 and keyboard 206. The sound card 203 converts analog speech input captured by the microphone 207 into digital speech samples. The digital speech samples are received by the SR unit 101 as speech input. Subsequent processing of the speech input is similar to the processing by the system 100 as already described above.

It should be noted that the computer system 200 described above is only one possible implementation of the system 100. The system 100 may be implemented in other devices, such as a mobile phone, in other embodiments.

FIG. 3 shows a flow-chart of a method for selection of text for editing according to an embodiment. Step 300 includes inputting text to an apparatus. The apparatus may refer to the computer system 200 or any devices implementing the text editing system 100. The text may be input to the apparatus directly in a text file in one embodiment. Alternatively, the text input may be generated as a result of a speech-to-text conversion from a speech recognition system in another embodiment.

Step 302 includes generating a label for at least one unit of text as the text is being input to the apparatus. In an embodiment, a label is generated automatically for every text unit received by the apparatus. The label generated is unique and associated with the corresponding text unit. Accordingly, a user can select a text unit simply by selecting the label associated with the text unit.

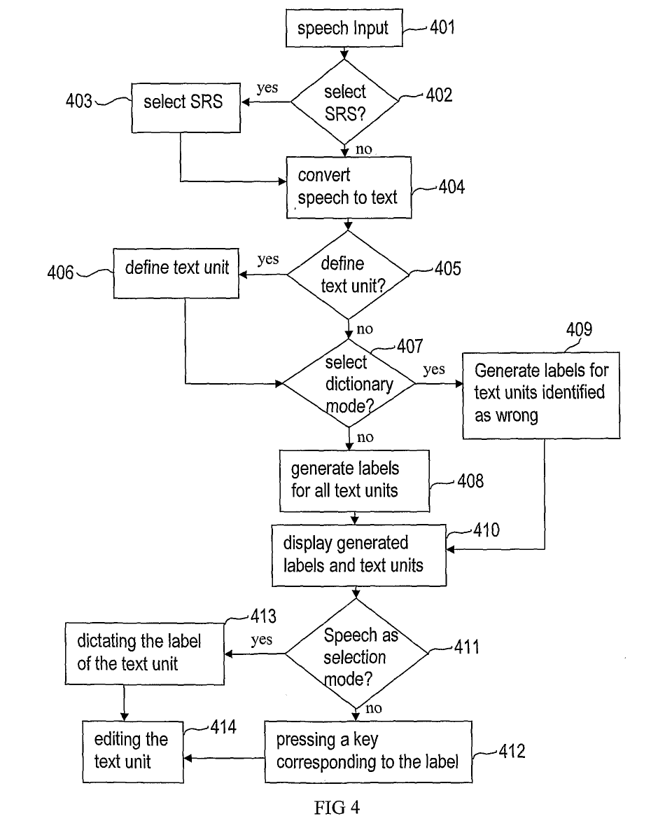

To illustrate the method of selection of text for editing according to the embodiment, a detailed example of the method is described. FIG. 4 shows a flow-chart of the detailed example of the method for text editing according to an embodiment. For ease of description, the flow-chart of FIG. 4 will be described with reference to the computer system 200. It should however be noted that the flow-chart is also applicable to other systems implementing the text editing method.

Step 401 includes providing speech input. The speech input may be provided by a user dictating to the microphone 207 connected to the computer system 200. The sound card 203 receives and converts the analog speech input into digital speech input for further processing by the computer system 200. Step 402 includes allowing the user to decide whether to select a speech recognition system for processing the speech input. The computer system 200 may include several speech recognition systems in the SR unit 101. The computer system 200 may display the available speech recognition systems to the user on the display 205, and the user selects the desired speech recognition system using the keyboard 206 at Step 403. Alternatively, the computer system 200 always uses a default speech recognition system unless the user chooses another speech recognition system to be used. In an embodiment, the computer system 200 may include only one speech recognition system. Accordingly, Step 402 and Step 403 may be omitted in this embodiment.

Step 404 includes converting the speech input into text. The conversion from speech to text is usually done by the speech recognition system after the speech input has been recognized. The converted text becomes the text input for the data unit 102. Step 405 includes asking the user whether he or she wants to define a text unit. A text unit may be defined as a character, a word, a phrase, a sentence, a line of the text or any other suitable units. If the user wants to define the text unit, he or she defines the text unit at Step 406. In an embodiment, the text unit is defined as a word by default. In an alternative embodiment, the user may define a line as a primary text unit and a word as a secondary text unit. The text unit (primary and/or secondary) definitions made by the user at Step 405 and Step 406 may be set as default, and hence, omitted for subsequent processing. The user proceeds to Step 406 only if he or she wants to change the definitions of the text unit.

Step 407 includes selecting the dictionary mode. In a default mode, the dictionary mode is not selected, and the label unit 103 of the computer system 200 proceeds to generate the labels for each text unit in Step 408. The labels for the text units may be numbers (for example 1, 2, 3, . . . ), characters (for example a, b, c, . . . ), symbols (for example @, #, $, . . . ) or words, or any labels that can be accurately recognized by the speech recognition system. In an alternative embodiment when the dictionary mode is selected at Step 407, the label unit 103 generates the labels only for text units which are identified as wrong by the dictionary unit 105 in Step 409.

Step 410 includes displaying the text units and the generated labels. If the dictionary mode was selected at Step 407, all the text units and the labels for those text units identified as wrong by the dictionary unit 105 are displayed. If the dictionary mode was not selected, all the text units and their corresponding labels are displayed. Each generated label may be displayed adjacent to its corresponding text unit in an embodiment. In alternative embodiments, each generated label may be displayed above or below its corresponding text unit. FIG. 5 shows an example of the labels being displayed in parenthesis at the right side of each word in a display screen 501 of a mobile phone 502. In this example, a word is defined as the text unit.

Step 411 includes choosing a mode for selecting the text unit for editing. In a default mode, speech selection mode is chosen. It is also possible for the user to choose a keyboard selection mode at Step 411. In the default speech selection mode at Step 413, the user selects the desired text unit by dictating the corresponding label of the desired text unit. In the keyboard selection mode at Step 412, the user selects the desired text unit by pressing one or more keys of the keyboard which corresponds to the label of the text unit.

In the embodiment when a line is defined as the primary text unit and a word as the secondary text unit, primary labels for the lines and secondary labels for the words in each line are generated. The labels for each line of the text are displayed. When one of the lines is selected, the secondary labels for the selected line are also displayed. It should be noted that the primary and the secondary text units may be defined differently in other embodiments. For example, the primary text unit may be defined as a paragraph, and the secondary text unit may be defined as a line in another embodiment.

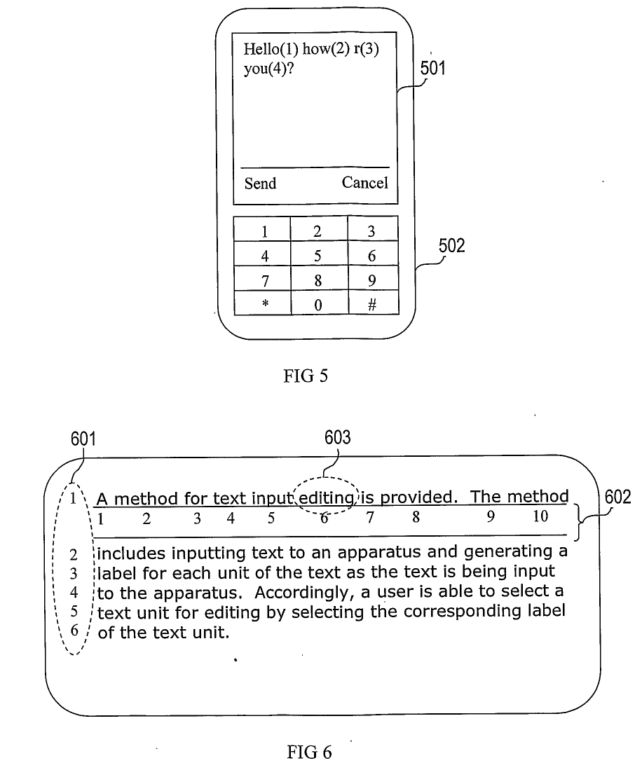

FIG. 6 shows an example of a text passage with the corresponding primary labels 601 and secondary labels 602 according to an embodiment. In this example of the embodiment, each line of the text passage is defined as the primary text unit. The line identified by label “1” is selected, and the secondary labels 602 for the selected line “1” are displayed. The user may select a word of the selected line by selecting the corresponding secondary label of the word. For example, the user may select the word “editing” 603 by selecting the primary label “1”, and subsequently selecting the secondary label “6”. In another embodiment, it is possible to select the words in the selected line by navigating using directional keys (not shown) provided on the keyboard or device.

Once the desired text unit is selected at Step 412 or Step 413, the user edits the selected text unit at Step 414. In an embodiment, the user edits the selected text unit by re-dictation. The user may also edit the selected text unit by entering the desired text unit using the keyboard or choosing from a list of alternative text units in other embodiments.

Although the present invention has been described in accordance with the embodiments as shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method of selection of text for editing, comprising:
inputting text to an apparatus; and
generating a label for at least one unit of the text as the text is being input to the apparatus, thereby allowing a user to select the at least one text unit for editing by selecting the corresponding label of the text unit.

2. The method of claim 1, wherein inputting text to the apparatus comprises:
providing a speech input; and
converting the speech input into text.

3. The method of claim 1, wherein the text unit and its corresponding label are displayed on a screen of the apparatus.

4. The method of claim 1, further comprising defining one of the following as the text unit:
a character;
a word;
a phrase;
a sentence;
a line of the text;
a paragraph of the text;
a page of the text;
a section of the text; and
a chapter of the text.

5. The method of claim 4, further comprising:
defining a secondary text unit; and
generating a secondary label for the secondary text unit.

6. The method of claim 5, wherein the text unit is defined as a line of text and the secondary text unit is defined as a word, thereby allowing the user to select the word by selecting the corresponding label and the secondary label.

7. The method of claim 1, wherein the label for the text unit is a number, a character, a word or a symbol.

8. The method of claim 1, wherein the label is located adjacent, below or above the corresponding text unit.

9. The method of claim 1, wherein the text unit is selected by dictating the corresponding label of the text unit, thereby providing a speech input which corresponds to the label of the text unit.

10. The method of claim 1, wherein the label of the text unit is selected by pressing at least one corresponding key of a keyboard connected to the apparatus.

11. The method of claim 1, further comprising re-inputting the text unit to the apparatus when the corresponding label for the text unit is selected.

12. The method of claim 3, further comprising:
comparing the text with a dictionary in the apparatus; and
displaying the label with the corresponding text unit only if the text in the corresponding text unit has been identified as wrong by the dictionary.

13. A system for selection of text for editing, comprising:
a data unit being adapted to receive text; and
a label unit being adapted to generate a label for at least one unit of the text as the text is being received, thereby allowing a user to select at least one text unit for editing by selecting the corresponding label of the text unit.

14. The system of claim 13, further comprising a speech recognition unit being adapted to receive speech input and to convert the speech input into text for the data unit.

15. The system of claim 13, further comprising a display unit for displaying the text unit and its corresponding label.

16. The system of claim 13, further comprising a definition unit being adapted to allow the user to define one of the following as the text unit:
a character;
a word;
a phrase;
a sentence;
a line of the text;
a paragraph of the text;
a page of the text;
a section of the text; and
a chapter of the text.

17. The method of claim 16, wherein the definition unit is further adapted to define a secondary text unit; and wherein the label unit is further adapted to generate a secondary label for the secondary text unit.

18. The system of claim 17, wherein the text unit is defined as a line of text and the secondary text unit is defined as a word, thereby allowing the user to select the word by selecting the corresponding label and the secondary label.

19. The system of claim 13, further comprising an input unit being adapted to receive an input signal, wherein the input signal corresponds to a selection of the corresponding label of the text unit.

20. The system of claim 19, wherein the input signal is a speech input and the input unit comprises a speech recognition system for recognizing the speech input.

21. The system of claim 19, wherein the input signal is a signal generated from a keyboard connected thereto.

22. The system of claim 13, wherein the data unit is further adapted to allow the user to re-enter the text unit when the corresponding label for the text unit is selected.

23. The system of claim 13, further comprising a dictionary unit being adapted to verify the accuracy of the text received by the data unit.

24. A computer readable medium having stored thereon one or more sequences of instructions for causing one or more processors to perform the method for text editing, the method comprising:
receiving a text input; and
generating a label for at least one unit of the received text input, thereby allowing a user to select the at least one text unit for editing by selecting the corresponding label of the text unit.
